(19) United States
(12) Patent Application Publication
(10) Pub. No.: US 2005/0260913 A1
(43) Pub. Date: Nov. 24, 2005

(54) Floor covering product including recycled material and method of making same

(76) Inventor: Van I. Doesburg, Dalton, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/902,426

(22) Filed: Jul. 28, 2004

Related U.S. Application Data
(60) Provisional application No. 60/573,560, filed on May 21, 2004.

(51) Int. Cl. B32B 3/02; D04H 11/00; D05C 17/00

(52) U.S. Cl. 442/370; 428/94; 428/95; 428/96; 428/97; 442/373; 442/387; 442/394; 442/401

(57) ABSTRACT

This invention is a floor covering which may be easily removed from its underlying surface and which resists buckling or folding when rolled, comprising: (a) a facing layer; (b) a release backing layer made of post-consumer recycled nonwoven polyester fabric of relatively short fibers, continuous filament fibers, or a mixture thereof and (c) an intermediate polymer layer which is bonded to the release backing layer on one side and directly or indirectly to the facing layer on the other side. A process for preparing a polyurethane foam cushioned floor covering is also disclosed.

### CROSS-REFERENCE TO RELATED APPLICATIONS

This application claims the benefit of provisional application Ser. No. 60/573,560, filed May 21, 2004.

### FIELD OF THE INVENTION

The present invention generally relates to a textile floor coverings utilizing recycled material. More particularly, this invention relates to laminated multi-layered carpet or carpet tile composites which include recycled polyester as one of the layers.

### BACKGROUND OF THE INVENTION

Manufacturing methods have been devised and improved for producing polymer-backed floor covering, particularly polyurethane foam-backed carpets and/or carpet tiles. One previously unsolved problem in connection with polymer-backed floor coverings and particularly in connection with polyurethane foam-backed carpet or carpet tile, relates to installation. When it was necessary to remove a glued down polymer backed carpet, the installer was faced with significant cost and effort. Typically, where multipurpose adhesives were used, the bond between the bottom of the polymer backing and the underlying surface would be sufficiently strong to cause the carpet or carpet tile to delaminate or the polymer backing to separate as the carpet or carpet tile was being pulled up, and thus to leave a residue of adhesive and portions of the polymer backing on the floor. This residue would have to be mechanically removed by scraping or vibrating, resulting in significant additional labor and its associated cost. Often, these costs exceeded the entire cost of replacing and installing the new carpet.

Such removal problems were to some extent alleviated with the advent of pressure sensitive adhesives, which in theory never fully harden, so that carpet or carpet tile may be applied, removed and reapplied repeatedly. However, due to the lack of internal strength in most polyurethane foam carpet or carpet tile cushions, portions of the polyurethane foam cushion would remain bonded to the floor even when these pressure releasable adhesives were used. Thus, time-consuming, expensive removal was still required.

The significance of this problem is demonstrated by the prevalence of an alternative method of securing carpeting by the use of tack strips. In the tack strip method, wooden strips are secured to the floor or underlying surface around the perimeter of the room. Padding is then placed on the surface and carpet is stretched over the padding and tacked to the strips. Removal of tacked down carpet leaves no residual adhesive or polymer backings. The tack strip method, however, requires skilled and trained installers and is relatively expensive.

These preexisting installation methods illustrate the desirability of a polymer-backed carpet product which can be glued to the floor using a pressure sensitive adhesive and removed at a later time by simply pulling the carpet from the floor, leaving the adhesive layer in a tacky state ready for installation of the next carpet product. Such a method would allow installers to change home carpeting requiring minimum time and effort. Similarly, in the contract or commercial carpet market, removal and installation costs are significantly reduced.

One known solution to the foregoing problem is to bond a woven polypropylene backing layer to the underside of such carpet products. The woven polypropylene backing layer may then be glued to the floor. When such a carpet product is pulled from the floor, the woven polypropylene backing layer provides the carpet product with sufficient mechanical strength to remain substantially intact.

Although the woven polypropylene backing layer provides a needed function for carpet products, it does not contribute significantly to the physical properties of the carpet product, such as dimensional stability. Therefore, it is expensive to include a manufactured product, such as a woven polypropylene backing layer, in a laminated multi-layered carpet product, when such layer does not contribute to the physical properties of the carpet product.

There is a general desire in today's society to recycle products so that they can be used a second time instead of manufactured once and discarded. What is needed, therefore, is a multi-layered laminated carpet product including a release backing layer that incorporates recycled materials.

### SUMMARY OF THE INVENTION

The present invention satisfies the foregoing need by providing a polymer-backed floor covering or pad which can be pulled from the floor where adhesives have been used, and is easily replaced, but which resists buckling and folding when rolled. The present invention therefore comprise a carpet product comprising a facing layer; an outermost release backing layer opposite the facing layer, the release backing layer comprising post consumer, nonwoven polyester fabric of relatively short fibers or continuous filament fibers; and an intermediate polymer layer which is bonded to the release backing layer on one side and directly or indirectly to the facing layer on the other side.

In another aspect, the present invention provides a process for preparing a polymer-backed floor covering, which process comprises applying a layer of an uncured polyurethane-forming composition to one side of a post consumer, nonwoven polyester fabric of relatively short fibers or continuous filament fibers, partially reacting the polyurethane-forming composition, and applying to the upper surface of said layer of partially reacted polyurethane-forming composition a textile layer, such that no additional layer(s) of adhesive is required to form the laminated composite.

The release backing layer of the present invention increases internal strength of the bottom side of the floor covering. Accordingly, the floor covering of this invention has much superior ability to resist tearing and delamination when removed from an installation in which it has been glued down. The floor covering exhibits improved ease of removal when all types of adhesives are used. However, less expense will be incurred and the advantages of easy removal and subsequent re-installation without the need to apply a new adhesive layer will be more effectively realized by using “permanent tack”, or pressure sensitive adhesives.

Accordingly, it is an object of the present invention to provide an improved carpet product.

Another object of the present invention is to provide a carpet product that requires relatively little labor to remove from an installation.

A further object of the present invention is to provide a carpet product that utilizes recycled materials.

Still another object of the present invention is to provide a carpet product that include a release backing layer made from post-consumer recycled material.

These and other objects, features and advantages of the present invention will become apparent upon reviewing the following detailed description of the disclosed embodiments and the appended drawing and claims.

### BRIEF DESCRIPTION OF THE DRAWINGS

FIG. 1 is a cross-sectional side view of a disclosed embodiment of a floor covering in accordance with to the present invention.

FIG. 2 is a cross-sectional side view of an alternate disclosed embodiment of a floor covering in accordance with to the present invention.

FIG. 3 is a cross-sectional side schematic view of a disclosed embodiment of a cushion in accordance with to the present invention.

FIG. 4 is a side schematic view of a machine for manufacturing floor covering according to the present invention.

### DETAILED DESCRIPTION OF THE INVENTION

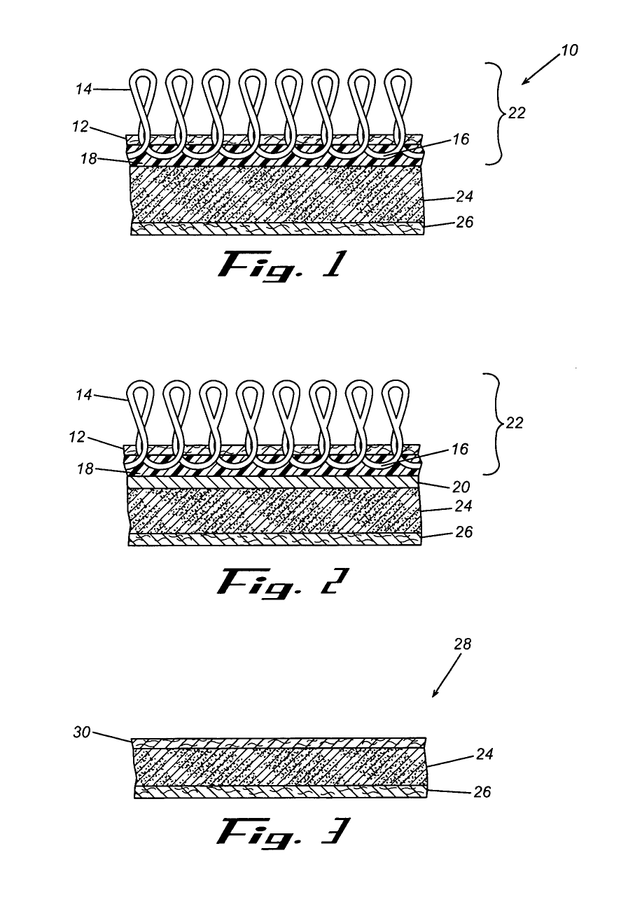

With reference to the drawing in which like numbers indicate like elements throughout the several views, it will be seen that there is disclosed a carpet product, such as a carpet 10 (FIG. 1), in accordance with the present invention. The carpet 10 comprises a primary carpet backing layer 12 through which loops of yarn are tufted in order to form a face pile 14 on one side of the primary backing. The face pile 14 may be looped, as shown in FIGS. 1 and 2, or it may be cut (not shown). Optionally, the loop backs 16 are secured to the primary carpet backing layer 12 with a layer of adhesive 18, such as a pre-coat layer of styrene butadiene rubber latex or polyurethane, applied to the side of the primary backing layer opposite the face pile 14. The specific material use for the layer of adhesive 18 is not critical to the present invention. Any adhesive typically used in the carpet industry as a pre-coat layer is useful in the present invention. The purpose of the layer of adhesive 18 is to hold the tufts of yarn in the primary carpet backing layer 12 so that they cannot be easily pulled out. Optionally, the carpet 10 may include a secondary backing layer 20 (FIG. 2). When a secondary backing layer 20 is utilized, it may be adhered to the primary backing layer 12 with the layer of adhesive 18. Optionally, the secondary backing layer 20, when utilized, may be adhered to the layer of adhesive 18 with an additional layer of adhesive (not shown) between the layer of adhesive 18 and the secondary backing layer. The material from which the secondary backing layer is made is not critical to the present invention. The secondary backing layer 20 may be made from any material typically used in the carpet industry for such purpose, such as a nonwoven polypropylene fabric known as ActionBac® available from Amoco Fabrics Company, Chicago, Ill.

Collectively, the face pile 14, the primary carpet backing 12, the loop backs 16, the optional adhesive layer 18 and the optional secondary backing layer 20 form a carpet facing layer 22. While the facing layer 22 of the carpet 10 had been illustrated in FIGS. 1 and 2 as a tufted carpet, the facing layer can be of any desired construction and composition. Such facing layer 22 may comprise, for example, a woven or tufted carpet of natural or synthetic materials with or without a pre-coat or secondary backing, or a woven or nonwoven scrim, a polymeric sheet material or like material. A flexible facing material such as is commonly employed in manufacturing carpet padding is also suitable. Such flexible facing is advantageously a non-woven material because it evenly disperses stresses and has few existing internal stresses, so that buckling, bubbling and wrinkling over a period of time is reduced. A woven or non-woven flexible facing may be needle-punched to reduce internal stresses and strains. The facing layer 22 advantageously has a weight of about 0.9 to about 85 ounces/square yard; preferably, about 2 to 80 ounces/square yard.

With reference to FIG. 1, a layer of polymeric foam 24 is adhered to the adhesive layer 18. With reference to FIG. 2, when a secondary backing layer 20 is utilized, the polymeric foam layer 24 is adhered to secondary backing layer. The polymeric foam layer 24 may be made from any polymeric foam typically used in the carpet industry to form a cushion pad for carpet, but it is preferably made from mechanically frothed polyurethane foam. The composition of the polymeric foam layer 24 is not critical to the present invention as long as the polymer-forming composition is a fluid mixture which subsequently cures or coalesces to form a flexible, non-fluid polymer. Suitable polymer-forming compositions include latexes such as aqueous styrene/butadiene dispersions, polyurethane-forming compositions and the like. Preferably, the polymer-forming composition forms a cellular polymer when cured or coalesced.

Adhered to the surface of the polymeric foam layer 24 opposite the facing layer 22, is a release backing layer 26. The release backing layer 26 comprises a nonwoven polyester fabric made from recycled materials; preferably, 100% recycled materials. The polyester fabric is preferably made from randomly oriented polymeric fibers made from polyethylene terephthalate derived primarily from discarded soda bottles. The polyester fabric preferably is made of relatively short fibers, continuous filament fibers or a mixture thereof. The polymeric fibers preferably having an average length of about 3/16 to about 12 inches; especially about 2 to about 8 inches. The release backing layer 26 preferably has a weight of about 0.9 to about 24 ounces per square yard. The polyester fabric is preferably either spun bonded or resin bonded. A recycled nonwoven polyester fabric suitable for use in the present invention is available under the designation 9000 Series PE from Synthetic Industries Inc., Chickamauga, Ga.

With reference to FIG. 3, there is shown a cushion pad 28 for use with carpet. The cushion pad 28 comprises a release backing layer 26 adhered to an intermediate polymeric foam layer 24 and a facing layer, such as a nonwoven polypropylene fabric layer 30, such as ActionBac®, adhered to the intermediate polymeric foam layer. The cushion pad may be manufactured in the same manner as the carpet 10 described herein, except that the primary carpet backing 12 is not adhered to the polypropylene fabric layer 30. Alternately, the carpet 10 can be made in a two-step process by first manufacturing the cushion pad 28, and then in a separate step adhering the cushion pad to the back of a carpet, such as to the primary carpet backing 12, with an adhesive, such as a hot melt adhesive.

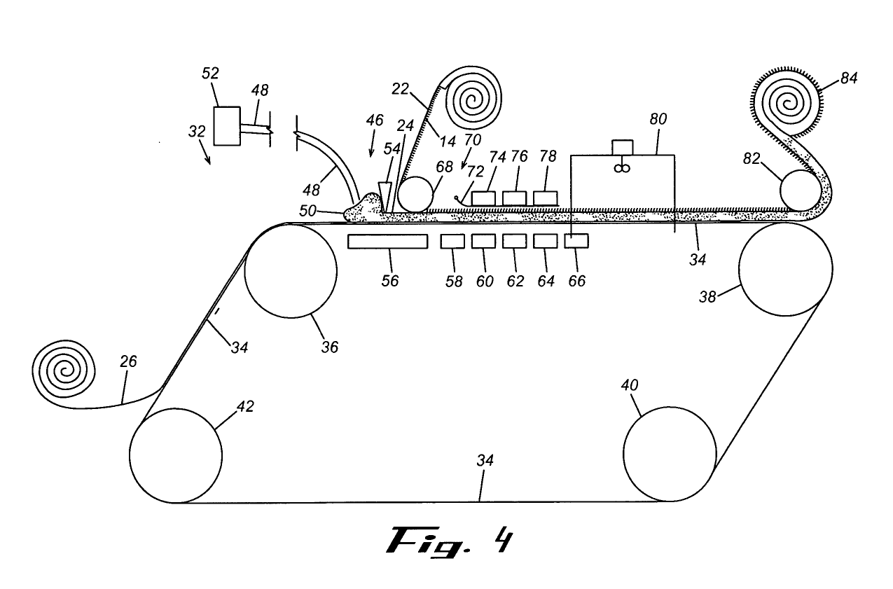

Manufacture of the carpet product of the present invention will now be considered. With reference to FIG. 4, there is shown a belted range 32 for manufacturing the carpet 10 or the cushion pad 28. The belted range 32 is of the designed disclosed in U.S. Pat. No. 6,491,977, incorporated herein by reference. Specifically, the belted range 32 includes a continuous Teflon coated belt 34 that extends in a continuous loop around rolls 36, 38, 40, 42. One or more of the rolls 26-40 is driven by a motor (not shown) which makes the belt 34 travel around the rolls in a continuous loop. Preferably, the drive motor (not shown) is controlled by a computer (not shown) so that the speed of the belt 34 can be controlled.

The manufacturing process begins by applying a release backing layer of nonwoven polyester fabric made from recycled material 26 onto the moving belt 34. The moving belt 34 carries the polyester fabric 44 to a polymeric foam deposition station 46 where polymeric foam is dispensed from a traversing hose 48 into a puddle 50 on the polyester fabric. The polymeric foam is preferably a mechanically frothed polyurethane foam. Suitable compositions for forming mechanically frothed polyurethane foams, and methods for applying same to a layer of fabric by means of a frothing mixer-generator or head 52 are taught in U.S. Pat. Nos. 3,821,130 and 4,296,159, both of which are incorporated herein by reference. According to this method, the frothing is accomplished by mechanically inducing an inert gas, preferably relatively moisture-free air or nitrogen, into a polyurethane-forming composition. This may be accomplished, for example, by feeding a stream comprising a mixture of urethane-forming components or separate streams of urethane-forming components and a stream of air, or other inert gas, into a suitable froth generator 52, such as an Oakes foamer, and connecting the mixer to the hose 48 whose free end is made to cyclically traverse the moving polyester fabric 44 to apply the polyurethane foam thereto. The froth density of the urethane composition is controlled by controlling the amount of gas introduced during frothing. The density of the polymeric foam is not critical. However, densities of the polymeric foam useful in the present invention include, but are not limited to, about 7 to about 35 pounds per cubic foot for polyurethane foams. As the release backing layer 26 advances past the polymeric foam deposition station 46, the puddle of foam 50 is formed into a polymeric foam layer 24 of desired thickness by passing the foam under a doctor bar 54. The thickness of the polymeric foam layer 24 is also not a critical aspect of the present invention. However, thickness of the polymeric foam layer useful in the present invention include, but are not limited to, about 0.080 to about 0.500 inches.

It should be noted that underlying the belt 34 and starting at the polymeric foam deposition station 46 are a series of heated plates 56, 58, 60, 62, 64, 66. The heated plates 56-66 provide heat to cure the polymeric foam layer 24. The heated plates 56-66 are preferably heated by passing low pressure steam through the heated plates. By controlling the amount of heat supplied to each plate 56-66, a desired cure profile can be provided to the polymeric foam layer 24.

After the polymeric foam has been formed into a layer 24 on the upper surface of the release backing layer 26, a facing layer(s) 22 is brought into contact with the upper surface of the polymeric foam layer before the upper surface thereof is cured. By contacting the facing layer 22 to the uncured foam layer 24, the facing layer becomes partially embedded in the foam layer, and, thereby, adheres the facing layer to the foam layer.

The facing layer 22, which in the illustration of FIG. 4 is a carpet from which face yarn 14 freely extend, is passed under a marriage bar 68 to marry the backing of the facing layer 22 to the upper surface of the layer of polymeric foam 24. The speed of the ladened belt 34 and of the facing layer 22 are set so that they pass through the polyurethane forming station 70 at the same velocity.

Immediately after the facing layer 22 is applied to the partially reacted polymeric foam layer 24, it is necessary to press the facing layer against the foam layer for a period of time from about 1 to 100 seconds, preferably about 30 to 50 seconds. This is accomplished by drawing the ladened belt 34 under a blanket of predetermined weight. The blanket comprises a low friction fabric 72, preferably Teflon coated fiberglass, which rides over the face yarn 14 of the carpet. A series of weights 74, 76, 78 is disposed on top of the low friction fabric 72, as disclosed in U.S. Pat. No. 6,491,977, incorporated herein by reference. The low friction fabric 72 is fastened at one end so that the blanket pressure is applied to the facing layer 22 immediately after the facing layer is applied to the polymeric foam layer 24.

After passing under the weighted blanket 72, the composite, comprising the release backing layer 26, the polymeric foam layer 24 and the facing layer 22, is heated for an additional time to affect the desired cure of the polymeric foam. This is accomplished by passing the belt 34 bearing the composite 22, 24, 26 through a force air over 80 to raise the temperature of the foam to about 150° to 350° F., preferably about 250° to 300° F. for a period of time sufficient to effect the substantially complete curing of the polymeric foam. Finally, the composite 26, 24, 22 is stripped from the belt 26, fed over a stripper roll 82 and onto a take-up reel 84.

The floor covering of the present invention may be applied to its underlying surface with conventional adhesives, pressure sensitive, or permanent tack adhesives. The latter are preferable because they decrease the possibility of delamination of the floor covering, and allow the installer to more easily remove and replace carpet without the necessity of removing the adhesive layer and applying another adhesive layer. Such adhesives are well known and may be used for carpet installation in accordance with manufacturers' instructions and recommendations.

As mentioned before, the advantages of this invention are most particularly seen when the polymer backing layer is a polyurethane foam, since these backings are particularly susceptible to tearing and delamination when removed from a glue down installation. Polyurethane foam layers are also preferred due to their general physical properties, including tenacious bonding to the primary backing 12 (often expressed as a high tuft lock), good dimensional stability and its ability to provide good cushioning to the carpet. Suitable polyurethane foam formulations are described, for example, in U.S. Pat. Nos. 3,821,130; 3,862,879; 4,296,159; 4,336,089; 4,397,978; 4,435,459; 4,483,894 and 4,525,405, all incorporated herein by reference.

The following example is intended to illustrate the present invention, but are not intended to limit the scope of the present invention in any manner.

### EXAMPLE 1

In a suitable container are thoroughly blended 100 parts of a 94:6 mixture of a 4800 molecular weight ethylene oxide-capped poly(propylene oxide) triol and ethylene glycol, 50 parts aluminum trihydrate and 60 parts calcium carbonate. Care is taken during mixing to exclude water. After mixing, the blend is cooled to about 72° F.

About 210 parts of this blend is mixed with 0.08 part of a catalyst, 0.15 parts of a 10% silicone surfactant solution in the polyol blend described above, and 40 parts of a 27.5% NCO prepolymer prepared by reacting toluene diisocyanate with a mixture of a 200 molecular weight poly(ethylene oxide) diol and 255 molecular weight poly(propylene oxide) triol. This blend is fed to an Oakes foamer in order to froth the material, using air as the gas. The resulting froth has a density of about 0.3 g/cc.

The froth is applied to the upper surface of a 100% post consumer, 100% polyester nonwoven fabric, sold under the designation 9000 Series PE and supplied by Synthetic Industries Inc. The foam-coated fabric is then passed under a doctor blade which shapes the froth into a layer of uniform 0.125″ thickness. The foam coating weight is about 23.5 ounces per square yard.

After the carpet passes the doctor knife, the underside of a carpet facing layer (Style No. 765, from Beaulieu Commercial) is placed onto the surface of the uncured froth. The resulting composite structure is heated at about 250°-275° F. until the froth is substantially cured. The foam-coated carpet is trimmed to a width of 12 feet and subsequently rolled up to a length of 100 feet. The carpet rolls up smoothly without buckling or folding. The foam layer of the foam-coated carpet has a density of 18 pounds per cubic foot, and a compression set of 8.5%.

The foam-coated carpet is installed in an office area using a pressure sensitive (permanent tack) adhesive. The adhesive is spread over the floor at a thickness of about 5-20 mils and allowed to dry. The carpet is then placed over the adhesive. Repeated removals of the carpet from the adhesive do not significantly damage the polyurethane backing, and repeated installation of the carpet provides a secure bond to the floor.

While the present invention has been disclosed as producing a carpet and a cushioned pad, it is also specifically contemplated the a carpet tile can be made using the present invention. In order to make a carpet tile, the secondary backing 20, shown in FIG. 2, is replaced with a layer of nonwoven fiberglass.

It should be understood, of course, that the foregoing relates only to certain disclosed embodiments of the present invention and that numerous modifications or alterations may be made therein without departing from the spirit and scope of the invention as set forth in the appended claims.

1. A floor covering comprising:
(a) a textile facing layer having a weight of about 8.0 to 80 ounces per square yard;
(b) a release backing layer having a weight from about 0.9 to 24 ounces per square yard, said release backing layer comprising a nonwoven polyester fabric of relatively short fibers, continuous filament fibers or a mixture thereof, wherein said nonwoven polyester fabric is made from recycled material; and
(c) an intermediate polymer layer which is bonded to the release backing layer on one side and directly or indirectly to the facing layer on the other side.

2. The floor covering of claim 1, wherein said release backing layer comprises randomly oriented polymeric fibers made from polyethylene terephthalate derived primarily from discarded soda bottles, said polymeric fibers having an average length of about 3/16 to about 12 inches.

3. The floor covering of claim 1, wherein said release backing layer is needle punched and said fibers have an average length of about 2 to about 8 inches.

4. The floor covering of claim 1, wherein said fibers are made from polyethylene terephthalate derived primarily from discarded soda bottles.

5. The floor covering of claim 2, wherein the surface of the release backing layer opposite the intermediate polymer layer is calendared.

6. The floor covering of claim 1, wherein said polymer layer comprises a polyurethane foam.

7. The floor covering of claim 6, wherein the polyurethane foam contains an inorganic filler comprising calcium carbonate.

8. The floor covering of claim 1, wherein the release backing layer of nonwoven polyester fabric is spun bonded.

9. The floor covering of claim 1, wherein the release backing layer of nonwoven polyester fabric is resin bonded.

10. A cushion pad comprising:
(a) a textile facing layer having a weight of about 0.9 to 60 ounces per square yard;
(b) a release backing layer having a weight from about 0.9 to 24 ounces per square yard, said release backing layer comprising a nonwoven polyester fabric of relatively short fibers, continuous filament fibers or a mixture thereof, wherein said nonwoven polyester fabric is made from recycled material; and
(c) an intermediate polymer foam layer which is bonded to the release backing layer on one side and directly or indirectly to the facing layer on the other side.

11. The cushion pad of claim 10, wherein said release backing comprises a nonwoven fabric comprised of randomly oriented polyethylene terephthalate fibers made primarily from discarded soda bottles, said fibers having an average length of about 3/16 to about 12 inches.

12. The cushion pad of claim 10, wherein said nonwoven polyester fabric is needle punched and said polymeric fibers have an average length of about 2 to about 8 inches.

13. The cushion pad of claim 11, wherein said polymeric fibers comprise continuous filament polyethylene terephthalate derived primarily from discarded soda bottles.

14. The floor covering of claim 10, wherein said polymer foam layer comprises a polyurethane foam.

15. The floor covering of claim 14, wherein the polyurethane foam contains an inorganic filler comprising calcium carbonate.

16. The floor covering of claim 10, wherein the release backing layer of nonwoven polyester fabric is spun bonded.

17. The floor covering of claim 10, wherein the release backing layer of nonwoven polyester fabric is resin bonded.

18. The floor covering of claim 1, wherein at least 50% of said nonwoven fabric is made from recycled material.

19. The floor covering of claim 10, wherein at least 50% of said nonwoven fabric is made from recycled material.
